(19) United States
(12) Patent Application Publication
(10) Pub. No.: US 2003/0036492 A1
(43) Pub. Date: Feb. 20, 2003

(54) Composition and method for bleaching a substrate

(75) Inventors: Andrew Paul Chapple, Bebington, (GB); Roelant Mathijs Hermant, Vlaardingen (NL); Kerry Elizabeth Hodkinson, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/117,681

(22) Filed: Apr. 5, 2002

(30) Foreign Application Priority Data
Apr. 6, 2001 (GB) 0108737.8

(51) Int. Cl. C11D 3/00

(52) U.S. Cl. 510/302; 510/376

(57) ABSTRACT

The invention relates to catalytically bleaching substrates, especially laundry fabrics, with a transition metal catalyst and an anionic surfactant that readily forms micelles at a low concentration in solution.

### FIELD OF INVENTION

This invention relates to compositions and methods for catalytically bleaching substrates in the absence of a peroxyl species using catalysts which beach via air sourced from the air.

### BACKGROUND OF INVENTION

Recently it has been found that selected organic molecules (ligands) and complexes may be used in air bleaching. Such ligands and complexes thereof are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537, WO 0052124 and W00060045.

The ligand may be present as a preformed complex of a ligand and a transition metal. Alternatively, the composition may comprise a free ligand that complexes with a transition metal ion present in tap water or stain on a substrate. The composition may also be formulated as a composition of a free ligand or a transition metal-substitutable metal-ligand complex, and a source of transition metal ion, whereby the complex is formed in situ in the wash medium.

Many transition metal complexes have high extinction coefficients in the visible. In this regard, use over time substantially in the absence of a peroxyl species may result in some colour deposition on a substrate after repeated washing. This colour deposition is indicative of transition metal complex deposition on the substrate. The rate and amount of colour deposition depends upon the nature of the transition metal complex and the substrate being bleached.

It is an object of the present invention to provide a composition substantially devoid of a peroxyl species with reduced colour deposition.

### SUMMARY OF INVENTION

The scope of the present invention also extends to the reduction in transition metal complex build-up on a substrate. Hence, the present invention is also applicable to transition metal complexes with low extinction coefficients in the UV-vis.

We have found that polyacrylic fabrics are susceptible to colour deposition when subjected to an air bleaching catalyst in the absence of a peroxyl species. We have also found that the use of an air bleaching catalyst in conjunction with anionic surfactants having particular properties serves to reduce colour deposition. We have been unable to find any non-ionic detergents per se that provide this effect.

The present invention also extends to reducing the deposition or incorporation of a ligand or transition metal catalyst thereof into any medium that the aforementioned species may partition into or bind thereto from an aqueous medium.

In this regard, the present invention provides a bleaching composition having reduced transition metal complex deposition properties comprising a ligand that forms a complex with a transition metal or a transition metal complex thereof the ligand comprising at least one heteroaromatic substituent, the bleaching composition forming in an aqueous solution an air bleaching medium, the bleaching composition having less that 1%, preferably less than 0.1%, of a peroxyl species present, characterised in that the bleaching composition comprises an anionic surfactant, wherein the anionic surfactant has a critical micelle concentration value of 3×10⁻³ M or less.

In another aspect the present invention provides a bleaching composition having reduced transition metal complex deposition properties comprising a ligand that forms a complex with a transition metal or a transition metal complex thereof the ligand, the bleaching composition forming in an aqueous solution an air bleaching medium, the bleaching composition having less that 1%, preferably less than 0.1%, of a peroxyl species present, characterised in that the bleaching composition comprises an anionic surfactant, wherein the anionic surfactant has a critical micelle concentration value of 3×10⁻³ M or less together with a base selected from at least at least 5 w/w % sodium carbonate and sodium bicarbonates.

Generally, a surfactant will form a micelle when present in an aqueous solution above a specific concentration that is intrinsic to the surfactant. A micelle is an electrically charged colloidal particle or ion, consisting of oriented molecules. Above what is known as the critical micelle concentration CMC amphiphilic compounds tend to adopt specific aggregates in aqueous solution. The tendency is to avoid contact between their hydrophobic alkyl chains and the aqueous environment and to form an internal hydrophobic phase. Such compounds can form monomolecular layers [monolayers] at the air-water boundary and bimolecular layers [bilayers] between two aqueous compartments. Micelles are spherically closed monolayers.

The particular property required is that the anionic surfactant used in the present invention is and forms a micelle at a concentration of 3×10⁻³ M and below in an aqueous solution at a temperature of 25° C. One skilled in the art will be aware that the standard CMC is measured in deionized water and that the presence of other components in solution, e.g. surfactants or ions in solution will perturb the CMC value. The CMC values and requirement thereof as described herein are measured under standard conditions (N. M. Van Os, J. R. Haak, and L. A. M Rupert, Pysico Chemical Properties of Selected Anionic Cationic and Nonionic Surfactants Elsevier 1993; Kresheck, G. C. Surfactants-In water a comparative treatise- (ed. F. Franks) Chapter 2 pp 95-197 Plenum Press 1971, New York; and, Mukerjee, P. and Mysels K. J. Critical Micelle Concentrations of Aqueous Surfactant Systems, NSRDS-NBS 36, National Bureau of Standards. US Gov. Print office 1971, Washington, D.C.). Accordingly, the present invention provides a bleaching composition having reduced transition metal complex deposition properties comprising a ligand that forms a complex with a transition metal, the bleaching composition forming in an aqueous solution an air bleaching medium, the bleaching composition having less that 1%, preferably less than 0.1%, of a peroxyl species present, characterised in that the bleaching composition comprises an anionic surfactant, wherein the anionic surfactant has a critical micelle concentration value of 3×10⁻³ M or less.

The anti-colour deposition property of the selected anionic surfactants is also enhanced by the presence of selected anions, namely carbonates and/or bicarbonates. These anions are preferable provided in the form of the sodium salt.

The anti-colour deposition property of the selected anionic surfactants is also enhanced by the presence of other surfactants other than anionic surfactants.

A unit dose as used herein is a particular amount of the bleaching composition used for a type of wash. The unit dose may be in the form of a defined volume of powder, granules, liquid or tablet.

A present invention also provides method of bleaching a substrate comprising applying to the substrate, in an aqueous medium, a bleaching composition as defined herein.

The present invention also extends to a commercial package comprising a bleaching composition according to the present invention together with instructions for its use.

The scope of the present invention also extends to the reduction in transition metal complex build-up on a substrate. Hence, the present invention is also applicable to transition metal complexes with low extinction coefficients in the UV-vis.

The composition of the present invention, in an air bleaching mode, is preferably substantially devoid of a peroxygen bleach or a peroxy-based or peroxyl-generating bleach system. The term “substantially devoid of a peroxygen bleach or a peroxy-based or peroxyl-generating bleach system” should be construed within spirit of the invention. It is preferred that the composition has as low a content of a peroxyl species present as possible. Nevertheless, autoxidation is something that is very difficult to avoid and as a result small levels of peroxyl species may be present. These small levels may be as high as 2% but are preferably below 2%. The level of peroxide present is expressed in mMol of hydroperoxide (—OOH) present per Kg. The additionally added organic compounds having labile CH's, for example allylic, benzylic, —C(O)H, and —CRH—O—R′, are particularly susceptible to autoxidation and hence may contribute more to this level of peroxyl species than other components. However the presence of an antioxidant in the composition will likely serve to reduce the presence of adventitious peroxyl species by reducing chain reactions. The composition of the present invention bleaches a substrate with at least 10%, preferably at least 50% and optimally at least 90% of any bleaching of the substrate being effected by oxygen sourced from the air.

When only a peroxyacid is present as a peroxyl bleaching species in a bleaching medium with a bleaching catalyst [total peroxyl present]=[RC(O)OOH]+[RC(O)OO⁻]. When a mixture of hydrogen peroxide and peroxyacid are present in this medium [total peroxyl present]=[RC(O)OOH]+[RC(O)OO⁻]+[H₂O₂]+[HOO⁻]. In some instances, the peroxy species will be relatively unreactive and hence the dominant conditions for “air bleaching” will be still be met by a relatively high level of peroxyl species present. The different proxyl species will react at different rates with an “air bleaching catalyst” but what is essential, for “air bleaching mode” is that k[air cat][peroxyl] is sufficiently small that k[air cat][O2] dominates to the extent that at least 10% of any bleaching of the substrate is effected by oxygen sourced from the air when the composition is for use in an air bleaching mode. When the composition is used in a peroxy mode there is sufficient peroxy species present to dominate and suppress “air bleaching” in the medium.

The composition provided by the present invention is such that in an aqueous solution at least 10%, preferably at least 50% and optimally at least 90% of any bleaching of a substrate is effected by oxygen sourced from the air.

### DETAILED DESCRIPTION OF THE INVENTION

Bleach Catalyst

The bleach catalyst per se may be selected from a wide range of organic molecules (ligands) and complexes thereof. Suitable organic molecules (ligands) and complexes for use with the present invention are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537; WO 0052124, and W00060045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane)of which the FeCl₂ salt thereof has the following extinction coefficients in acetonitrile: _{381 nm}=8400 M⁻¹ cm⁻¹ and ε_{458 nm}=6400 M⁻¹ cm⁻¹. In contrast to the highly coloured FeCl₂ salt of MeN4Py, 5,12-dimethyl-1,5,8,12-tetraaza-bicyclo[6.6.2]hexadecane manganese (II) chloride has a low absorption in the UV visible. The manganese salts of 1,4,7-trimethyl-1,4,7-triazacyclononane has a strong absorption in the UV visible (the manganese salts in their crystalline state have an intense purple colour). Of the ligands used in the present invention it is preferred that the ligand comprises at least one heteroraomatic substituent, it is preferred that the heteroraomatic substituent is a pyridine substituent, and it is most preferred that the heteroraomatic substituent is a pyridin-2-yl moiety. It is even more preferred if the ligand comprises at least two heteroraomatic substituents, it is preferred that the heteroraomatic substituents are pyridine substituents, and it is most preferred that the heteroraomatic substituents are pyridin-2-yl moieties. Of the ligands detailed above it is preferred that the ligand is other than a cross-bridged macropolycyclic ligand having at least two bridgehead nitrogen donor atoms. The term “a cross-bridged macropolycyclic ligand having at least two bridgehead nitrogen donor atoms” will be evident to one skilled in the art but for further direction the reader is directed to WO01/48299.

The air bleaching catalysts as used herein should not be construed as a peroxyl-generating system, alone or in combination with other substrates, irrespective of how the bleaching action works.

Another example of an air bleaching catalyst is a ligand or transition metal catalyst thereof of a ligand having the formula (I):

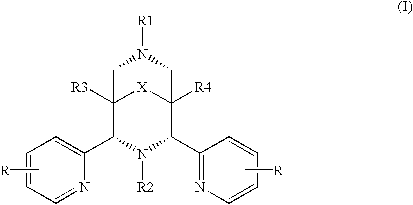

wherein each R is independently selected from: hydrogen, hydroxyl, and C1-C4-alkyl;

R1 and R2 are independently selected from:

C1-C4-alkyl,

C6-C10-aryl, and,

a group containing a heteroatom capable of coordinating to a transition metal, wherein at least one of R1 and R2 is the group containing the heteroatom;

R3 and R4 are independently selected from hydrogen, C1-C8 alkyl, C1-C8-alkyl-O—C1-C8-alkyl, C1-C8-alkyl-O—C6-C10-aryl, C6-C10-aryl, C1-C8-hydroxyalkyl, and —(CH2)₁C(O)OR5 wherein R5 is C1-C4-alkyl, n is from 0 to 4, and mixtures thereof; and,

X is selected from C═O, -[C(R6)₂]_{y}—wherein Y is from 0 to 3 each R6 is independently selected from hydrogen, hydroxyl, C1-C4-alkoxy and C1-C4-alkyl.

It is preferred that the group containing the hetroatom is: a heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; tetrahydropyranyl; and oxazolidinyl, wherein the heterocycloalkyl may be connected to the ligand via any atom in the ring of the selected heterocycloalkyl,

a —C1-C6-alkyl-heterocycloalkyl, wherein the heterocycloalkyl of the —C1 -C6-heterocycloalkyl is selected from the group consisting of: piperidinyl; piperidine; 1,4-piperazine, tetrahydrothiophene; tetrahydrofuran; pyrrolidine; and tetrahydropyran, wherein the heterocycloalkyl may be connected to the —C1-C6-alkyl via any atom in the ring of the selected heterocycloalkyl, a —C1-C6-alkyl-heteroaryl, wherein the heteroaryl of the —C1-C6-alkylheteroaryl is selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the —C1-C6-alkyl via any atom in the ring of the selected heteroaryl and the selected heteroaryl is optionally substituted by —C1-C4-alkyl,

a 13 C0-C6-alkyl-phenol or thiophenol,

a —C2-C4-alkyl-thiol, thioether or alcohol,

a —C2-C4-alkyl-amine, and

a -C2-C4-alkyl-carboxylate.

The ligand forms a complex with one or more transition metals, in the-latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

The transition metal complex preferably is of the general formula (AI):

[MₐLₖXₙ]Yₘ

in which:

M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

In typical washing compositions the level of the catalyst is such that the in-use level is from 0.1 μM to 50 mM, with preferred in-use levels for domestic laundry operations falling in the range 1 to 10 μM. Higher levels may be desired and applied in industrial bleaching processes, such as textile and paper pulp bleaching.

Preferably, the aqueous medium has a pH in the range from pH 6 to 13, more preferably from pH 6 to 11, still more preferably from pH 8 to 11, and most preferably from pH 8 to 10, in particular from pH 9 to 10.

The bleaching composition of the present invention has particular application in detergent formulations, especially for laundry cleaning. Accordingly, in another preferred embodiment, the present invention provides a detergent bleach composition comprising a bleaching composition as defined above and additionally a surface-active material, optionally together with detergency builder.

In addition to the requirement of the anionic surfactant, the bleach composition according to the present invention may for example contain additional surface-active material in an amount of from 10 to 50% by weight. The surface-active material may be naturally derived, such as soap, or a synthetic material selected from anionic, nonionic, amphoteric, zwitterionic, cationic actives and mixtures thereof. Many suitable actives are commercially available and are fully described in the literature, for example in “Surface Active Agents and Detergents”, Volumes I and II, by Schwartz, Perry and Berch.

Typical synthetic anionic surface-actives are usually water-soluble alkali metal salts of organic sulphates and sulphonates having alkyl groups containing from about 8 to about 22 carbon atoms, the term “alkyl” being used to include the alkyl portion of higher aryl groups. Examples of suitable synthetic anionic detergent compounds are sodium and ammonium alkyl sulphates, especially those obtained by sulphating higher (C₈-C₁₈) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralised with sodium hydroxide; sodium and ammonium salts of fatty acid amides of methyl taurine; alkane monosulphonates such as those derived by reacting alpha-olefins (C₈-C₂₀) with sodium bisulphite and those derived by reacting paraffins with SO₂ and Cl₂ and then hydrolysing with a base to produce a random sulphonate; sodium and ammonium (C₇-C₁₂) dialkyl sulphosuccinates; and olefin sulphonates, which term is used to describe material made by reacting olefins, particularly (C₁₀-C₂₀) alpha-olefins, with SO₃ and then neutralising and hydrolysing the reaction product. The preferred anionic detergent compounds are sodium (C₁₀-C₁₅) alkylbenzene sulphonates, and sodium (C₁₆-C₁₈) alkyl ether sulphates.

Examples of suitable nonionic surface-active compounds which may be used, preferably together with the anionic surface-active compounds, include, in particular, the reaction products of alkylene oxides, usually ethylene oxide, with alkyl (C6-C₂₂) phenols, generally 5-25 EO, i.e. 5-25 units of ethylene oxides per molecule; and the condensation products of aliphatic (C₈-C₁₈) primary or secondary linear or branched alcohols with ethylene oxide, generally 2-30 EO. Other so-called nonionic surface-actives include alkyl polyglycosides, sugar esters, long-chain tertiary amine oxides, long-chain tertiary phosphine oxides and dialkyl sulphoxides.

Amphoteric or zwitterionic surface-active compounds can also be used in the compositions of the invention but this is not normally desired owing to their relatively high cost. If any amphoteric or zwitterionic detergent compounds are used, it is generally in small amounts in compositions based on the much more commonly used synthetic anionic and nonionic actives.

The detergent bleach composition of the invention will preferably comprise from 1 to 15% wt of anionic surfactant and from 10 to 40% by weight of nonionic surfactant.

The bleach composition of the present invention may also contain a detergency builder, for example in an amount of from about 5 to 80% by weight, preferably from about 10 to 60% by weight.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in US-A-4,144,226 and US-A-4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the compositions of the invention may contain any one of the organic and inorganic builder materials, though, for environmental reasons, phosphate builders are preferably omitted or only used in very small amounts. Typical builders usable in the present invention may be present at up to 30% w/w, and are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

Apart from the components already mentioned, the bleach composition of the present invention can contain any of the conventional additives in amounts of which such materials are normally employed in fabric washing detergent compositions. Examples of these additives include buffers such as carbonates, lather boosters, such as alkanolamides, particularly the monoethanol amides derived from palmkernel fatty acids and coconut fatty acids; lather depressants, such as alkyl phosphates and silicones; anti-redeposition agents, such as sodium carboxymethyl cellulose and alkyl or substituted alkyl cellulose ethers; stabilisers, such as phosphonic acid derivatives (i.e. Dequest® types); fabric softening agents; inorganic salts and alkaline buffering agents, such as sodium sulphate and sodium silicate; and, usually in very small amounts, fluorescent agents; perfumes; enzymes, such as proteases, cellulases, lipases, amylases and oxidases; germicides and colourants.

Transition metal sequestrants such as EDTA, and phosphonic acid derivatives such as EDTMP (ethylene diamine tetra(methylene phosphonate)) may also be included, in addition to the ligand specified, for example to improve the stability sensitive ingredients such as enzymes, fluorescent agents and perfumes, but provided the composition remains bleaching effective. However, the composition according to the present invention containing the ligand, is preferably substantially, and more preferably completely, devoid of transition metal sequestrants (other than the ligand).

The composition may contain additional enzymes as found in WO 01/00768 Al page 15, line 25 to page 19, line 29, the contents of which are herein incorporated by reference.

### EXAMPLES

Synthesis

[(MeN4Py)FeCl]Cl

The ligand N,N-bis(pyridin- 2-yl-methyl)-1,1-bis(pyridin-2-yl)-1-aminoethane (MeN4py) was prepared as described in EP 0 909 809 A2.

The ligand MeN4Py (33.7 g; 88.5 mmoles) was dissolved in dry methanol (500 ml). Small portions of FeCl₂.4H20 (0.95 eq; 16.7 g; 84.0 mmoles) were added, yielding a clear red solution. After addition, the solution was stirred for 30 minutes at room temperature, after which the methanol was removed (rotary-evaporator). The dry solid was ground and 150 ml of ethylacetate was added and the mixture was stirred until a fine red powder was obtained. This powder was washed twice with ethyl acetate, dried in the air and further dried under reduced pressure vacuum at 40° C. El. Anal. Calc. for [Fe(MeN4py)Cl]Cl.2H₂O: C 53.03; H 5.16; N 12.89; Cl 13.07; Fe 10.01%. Found C 52.29/52.03; H 5.05/5.03; N 12.55/12.61; Cl: 12.73/12.69; Fe: 10.06/10.01%.

Washing Experiments

The following washing experiments were carried out in tergotometer at 25° C. using 500 ml of test solution. The test solutions each contained [(MeN4Py)FeCl]Cl catalyst at a concentration of 0.001 g in 500 ml in addition to the other components at concentrations shown in the following tables. To this solution was added approximately 20 g of white knitted acrylic test monitors (15 cm×15 cm pieces) whose reflectance had previously been measured and recorded using a Hunterlab Ultrascan XE. Washing of the monitors was then carried out for 30 minutes with continual agitation at 100 revolutions per minute. After washing, the acrylic monitors were wrung out by hand and given a single rinse by immersion in tap water at a liquor to cloth ratio of 100:1. This wash sequence was then repeated a further four times on the same monitor cloths each time with a fresh batch of the same test solution. After rinsing on the final (fifth) wash cycle, the monitor cloths were line-dried under ambient laboratory conditions.

When dry, the reflectance of the monitor cloths was re-measured using a Hunterlab Ultrascan XE and the change in reflectance (after wash—before wash) calculated as Delta E (CIELAB). The measured colour difference (ΔE) between the washed cloth and the unwashed cloth is defined as follows:

ΔE=[(ΔL)²+(Δa)²+(Δb)²]^{½}

wherein ΔL is a measure for the difference in darkness between the washed and unwashed test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978.

Table 1 below shows the critical micelle concentration (CMC) values for a series of anionic surfactants.

TABLE 1

| Soap Surfactant | CMC (25° C.) |
|---|---|
| Sodium Oleate | 7.3 × 10⁻⁴ M |
| Sodium Linoleate | 1.8 × 10⁻³ M |
| Sodium Stearate | 1.9 × 10⁻⁴ M |
| Sodium Iso-Stearate | 4 × 10⁻⁴ M |
| Sodium Myristate | 4.3 × 10⁻³ M |
| Sodium Laurate | 2 × 10⁻² M |

Table 2 below shows the LE values obtained from a series of wash experiments carried out with different anionic surfactants.

TABLE 2

| Anionic Surfactant | ΔE |
|---|---|
| Sodium Isostearate (0.25 g/500 ml) | 0.18 |
| Sodium Oleate (0.25 g/500 ml) | 0.6 |
| Sodium Linoleate(0.25 g/500 ml) | 1.7 |
| Sodium Stearate(0.25 g/500 ml) | 4.0 |
| Sodium Myristate(0.25 g/500 ml) | 5.7 |
| Sodium Laurate(0.25 g/500 ml) | 5.8 |
| Water only (control) | 6.8 |

The following Table 3 below shows the CMC of anionic surfactant, molar concentration of anionic surfactant obtained (0.25 g/500 ml), and ΔE values obtained from the experimental results given above.

TABLE 3

| Anionic Surfactant | Conc/M | CMC/M | ΔE |
|---|---|---|---|
| Sodium Isostearate | 1.63 × 10⁻³ | 4 × 10⁻⁴ | 0.18 |
| Sodium Oleate | 1.64 × 10⁻³ | 7.3 × 10⁻⁴ | 0.6 |
| Sodium Linoleate | 1.65 × 10⁻³ | 1.8 × 10⁻³ | 1.7 |
| Sodium Stearate | 1.63 × 10⁻³ | 1.9 × 10⁻⁴ | 4.0 |
| Sodium Myristate | 2.00 × 10⁻³ | 4.3 × 10⁻³ | 5.7 |
| Sodium Laurate | 2.50 × 10⁻³ | 2 × 10⁻² | 5.8 |
| Water only (control) | — | — | 6.8 |

Table 4 below shows the ΔE values obtained for series of wash experiments carried out with different anionic surfactants.

TABLE 4

| Anionic Surfactant | CMC/M | ΔE |
|---|---|---|
| Dobanol ® 25 S3 (SLES) | 8.5 × 10⁻⁴ | 2.0 |
| (0.25 g/500 ml) | | |
| LAS (linear alkyl benzene | 1.5 × 10⁻³ | 4.6 |
| sulphonate) (0.25 g/500 ml) | | |
| Sodium dodecyl sulphate | 8 × 10⁻³ | 5.9 |
| (0.25 g/500 ml) | | |
| AOS(alpha-olefin-sulphonate) | 5-10 × 10⁻³ | 6.0 |
| (0.25 g/500 ml) | | |

The results given in Tables 2 to 4 above are indicative that the presence of an anionic surfactant having a critical micelle concentration value of 3×10⁻³ M or less has a significant effect in reducing colour deposition on fabrics. There was observed a substantial reduction in colour deposition when LAS (CMC=1.5×10⁻³ M) is used as a surfactant over Sodium Myristate (CMC=4.3×10⁻³ M). LAS and Sodium Myristate straddle the threshold value CMC value of 3×10 ⁻³ M.

Table 5 below shows the ΔE values obtained for series of wash experiments carried out with different commercially available anionic surfactants (fatty acid mixtures). The fatty acid mixtures were neutralised with sodium hydroxide solution equivalent to the corresponding soap mixtures before use. Prifac® 5916 (ex Unichema®) is a fatty acid mixture containing greater than 70% of fatty acids of chain length less or equal to C14. Priolene® 6907 (ex Unichema®) is a fatty acid mixture containing in excess of 70% oleic acid.

TABLE 5

| | ΔE |
|---|---|
| Prifac ® 5916(0.25 g/500 ml) | 8.2 |
| Priolene ® 6907 (0.5 g/500 ml) | 0.6 |

The results given in Table 5 are indicative that commercial mixture of alkali metal fatty acid anionic surfactants containing the presence of an anionic surfactant having a critical micelle concentration value of 3×10⁻³ M or less may be employed to reduce colour deposition on fabrics.

Table 6 below shows the ΔE values obtained for series of wash experiments carried out with nonionic surfactants.

TABLE 6

| Nonionic surfactant | ΔE |
|---|---|
| Neodol ® 25 7EO (0.65 g/500 ml) | 7.4 |
| Imbentin ® AG124 S/065 (0.25 g/500 ml) | 6.4 |

The results given in Table 6 above are indicative that nonionic surfactants are not effective in reducing colour deposition.

Table 7 below shows the ΔE values obtained for series of wash experiments carried out with a combination of an anionic and a nonionic surfactant.

TABLE 7

| Anionic/Nonionic Surfactant Mixtures | ΔE |
|---|---|
| LAS(0.25 g/500 ml)/Imbentin ® AG124 S/065 | 3.5 |
| (0.25 g/500 ml) | |
| Sodium Laurate (0.25 g/500 ml)/Imbentin ® AG124 | 3.3 |
| S/065 (0.25 g/500 ml) | |

The results given in Table 7 above are indicative that the reduced colour deposition due to the presence of an anionic surfactant is enhanced by the presence of a nonionic surfactant. When sodium laurate (0.25 g/500 ml) is used under similar conditions without another surfactant a ΔE value of 5.8 is obtained as shown in Tables 2 and 3.

Table 8 below shows the ΔE values obtained for series of wash experiments carried out with different anionic surfactants at varying concentrations.

TABLE 8

| Surfactant Level | Conc/M | ΔE |
|---|---|---|
| Water Only | — | 6.8 |
| Sodium Oleate (0.02 g/500 ml) | 1.31 × 10⁻⁴ | 4.7 |
| Sodium Oleate (0.05 g/500 ml) | 3.28 × 10⁻⁴ | 4.1 |
| Sodium Oleate (0.1 g/500 ml) | 6.57 × 10⁻⁴ | 2.6 |
| Sodium Oleate (0.25 g/500 ml) | 1.64 × 10⁻³ | 0.6 |

Table 9 below shows the ΔE values obtained for series of wash experiments carried out with different inorganic salts, some at varying concentrations.

TABLE 9

| Inorganic Salts | ΔE |
|---|---|
| Sodium Carbonate (0.5 g/500 ml) | 4.9 |
| Sodium Carbonate (0.25 g/500 ml) | 6.2 |
| Sodium Bicarbonate (0.5/500 ml) | 5.0 |
| Sodium Bicarbonate (0.25 g/500 ml)5 g/500 ml) | 6.2 |
| Sodium Tripolyphosphate (0.4 g/500 ml) | 7.5 |
| Tri-sodium Citrate (0.25 g/500 ml) | 6.9 |
| Sodium Acetate (0.25 g/500 ml) | 6.1 |
| Sodium Chloride (0.5 g/500 ml) | 5.9 |
| Sodium Sulphate (0.5 g/500 ml) | 6.1 |

The results given in Table 9 above are indicative that inorganic salts have an effect in reducing colour deposition. Of the salts tested both carbonate and bicarbonate salts are the most effective in reducing colour deposition.

Table 10 shows the effect of carbonate salts in combination with anionic and nonionic surfactants.

TABLE 10

| Components | ΔE |
|---|---|
| LAS (0.25 g/500 ml) | 4.6 |
| LAS(0.25 g/500 ml)/Sodium carbonate(0.3 g/500 ml) | 4.0 |
| LAS(0.25 g/500 ml)/Imbentin ® AG124 S/065 | 2.2 |
| (0.25 g/500 ml)/Carbonate(0.5 g/500 ml) | |

The results given in Table 10 above are indicative that anionic surfactants in combination with a non-ionic surfactant and an alkali carbonate salt are effective in reducing colour deposition.

Below are provided suitable composition for use with the present invention in which an air bleaching catalyst may be incorporated in the range 0.005 to 0.1 wt/wt %. It is preferred that a unit dose provides in an aqueous wash solution a concentration of a ligand or transition metal thereof (air bleaching catalyst) in the range of 0.5 to 5 μM, most preferably 1 to 2 μM.

| component | % |
|---|---|
| Composition formulation A: | |
| (Coco) PAS (CMC of 2.1 × 10⁻³ M) | 10% |
| Nonionic surfactant, ethoxylated fatty | 18.4% |
| alcohol type | |
| Oleic acid | 10% |
| Deflocculating polymer, polymer All from | 1% |
| EP346,995 | |
| silicon oil to control foam | 0.03% |
| KOH | 4.1% |
| NaOH | 0.9% |
| Citric acid.H2O | 5.5% |
| Glycerol | 5% |
| Borax | 1.9% |
| Anti-dye transfer polymer | 0.3% |
| Protease | 0.3% |
| Lipolase | 0.37% |
| Amylase | 0.15% |
| Perfume | 0.47% |
| Composition formulation B: | |
| LAS | 24 |
| Sodium TripolyPhosphate (STP) | 14.5 |
| SCMC | 0.33 |
| Acusol 479 | 1.5 |
| Fluorescer | 1.54 |
| Protease | 0.94 |
| Lipolase | 0.19 |
| Amylase | 0.28 |
| Cellulase | 0.2 |
| Sodium Carbonate | 17.5 |
| Sodium Silicate | 6.9 |
| Sodium Sulphate | 25 |
| Moisture | To 100% |

1. A bleaching composition having reduced transition metal complex deposition properties comprising a ligand that forms a complex with a transition metal or a transition metal complex thereof the ligand comprising at least one heteroaromatic substituent, the bleaching composition forming in an aqueous solution an air bleaching medium, the bleaching composition having less than 1% of a peroxyl species present, together with an anionic surfactant, said anionic surfactant having a critical micelle concentration value of 3×10⁻³ M or less.

2. A bleaching composition according to claim 1, wherein the anionic surfactant has a critical micelle concentration value of 2×10⁻³ M or less.

3. A bleaching composition according to claim 1, wherein a unit dose of the bleaching composition provides a concentration of the anionic surfactant in an aqueous solution of at least 1×10⁻⁴ M.

4. A bleaching composition according to claim 3, wherein a unit dose of the bleaching composition provides a total anionic surfactant concentration in an aqueous solution of at least 5×10⁻⁴ M.

5. A bleaching composition according to claim 1, wherein the bleaching composition comprises an alkali metal salt of an anion selected from the group consisting of carbonate and bicarbonates, preferably present in the composition at a concentration of at least 5 w/w %.

6. A bleaching composition according to claim 1, wherein a unit dose of the bleaching composition provides a concentration of carbonate in an aqueous solution of at least 1×10⁻³ M.

7. A bleaching composition according to claim 5, wherein the alkali metal salt is sodium.

8. A bleaching composition according to claim 1, wherein the bleaching composition comprises a nonionic surfactant, at a level of at least 1 w/w %.

9. A bleaching composition according to claim 1, wherein the anionic surfactant is selected from the group consisting of linear alkyl benzene sulphonate (LAS), sodium C12-C15-alkyl ether sulphate, sodium oleate, sodium linoleate, sodium isostearate and sodium Stearate.

10. A bleaching composition according to claim 1, wherein the ligand in the form of a transition metal complex selected from group consisting of Fe, Co, or Mn has an extinction coefficient (ε) in an acetonitrile solution of at least 2000 Mcm² within the UV-vis range of 330 nm to 650 mn.

11. A bleaching composition according to claim 1, wherein the ligand comprises at least one pyridin-2-yl moiety.

12. A bleaching composition according to claim 1, wherein the ligand comprises at least two pyridin-2-yl moieties.

13. A bleaching composition according to claim 1, wherein the ligand is other than a cross-bridged macropolycyclic ligand having at least two bridgehead nitrogen donor atoms.

14. A bleaching composition according to claim 1, wherein the ligand is N,N-bis(pyridin-2-yl-methyl)-1,1-bis(pyridin-2-yl)-1-aminoethane.

15. A bleaching composition according to claim 1, wherein the composition comprises a preformed complex of the ligand and a transition metal.

16. A bleaching composition according claim 1, wherein the ligand is present as a free ligand that complexes with a transition metal selected from the source of: transition metal present in the bleaching composition, adventitious transition metal ions present in tap water, and transition metal ions present in a stain.

17. A bleaching composition according to claim 1, comprising a builder.

18. A method of bleaching a substrate comprising applying to the substrate, in an aqueous medium, a bleaching composition as defined in claim 1.

19. A method for reducing partitioning of a ligand or transition metal complex thereof from an aqueous medium into a substrate, the method comprising the step of treating said substrate with an aqueous solution of said ligand or said transition metal complex thereof in the presence of an anionic surfactant, said anionic surfactant having a critical micelle concentration value of 3×10⁻³ M or less.

20. A bleaching composition having reduced transition metal complex deposition properties comprising a ligand that forms a complex with a transition metal or a transition metal complex thereof, the bleaching composition forming in an aqueous solution an air bleaching medium, the bleaching composition having less that 1% of a peroxyl species present, together with an anionic surfactant, said anionic surfactant having a critical micelle concentration value of 3×10⁻³ M or less together with a base selected from at least at least 5 w/w % sodium carbonate and sodium bicarbonates.

21. A bleaching composition according to claim 19, wherein the base is sodium carbonate and the ligand comprises at least one heteroaromatic substituent.
